(19) United States
(12) Patent Application Publication
(10) Pub. No.: US 2024/0210987 A1
(43) Pub. Date: Jun. 27, 2024

(54) ELECTRONIC APPARATUS AND MANUFACTURING METHOD FOR ELECTRONIC APPARATUS

(71) Applicant: LENOVO (SINGAPORE) PTE. LTD., SINGAPORE (SG)

(72) Inventors: Hiroaki Kinoshita, YOKOHAMA (JP); Takayuki Morino, YOKOHAMA (JP); Takehito Yamauchi, YOKOHAMA (JP); So Nakanishi, YOKOHAMA (JP)

(73) Assignee: LENOVO (SINGAPORE) PTE. LTD., SINGAPORE (SG)

(21) Appl. No.: 18/476,416

(22) Filed: Sep. 28, 2023

(30) Foreign Application Priority Data
Dec. 26, 2022 (JP) 2022208014

(51) Int. Cl. G06F 1/16

(52) U.S. Cl. CPC G06F 1/1605; G06F 1/1603

(57) ABSTRACT

An electronic apparatus includes a chassis; a display mounted on the chassis, a camera which is mounted on the chassis and has a light receiving section that receives light; and a plate-shaped cover member that covers the camera. Formed on the cover member are a light transmission section that encompasses the light receiving section as viewed from the direction of the optical axis of the camera, a ring-shaped low transmission section surrounding the light transmission section, and a light shielding section surrounding the low transmission section. The low transmission section has a transmittance of 80% or more of infrared rays of a wavelength of 850 nm as compared with the light transmission section. The low transmission section has a transmittance of 20% or less of visible rays of a wavelength of 550 nm as compared with the light transmission section.

### BACKGROUND OF THE INVENTION

### Field of the Invention

The present invention relates to an electronic apparatus and a manufacturing method for the electronic apparatus.

### Description of the Related Art

In an electronic apparatus such as a laptop personal computer, a camera may be provided on a bezel (refer to, for example, Japanese Unexamined Patent Application Publication No. 2020-201886). The camera may have a concave-convex engagement section formed on the outer peripheral edge of a lens holder. The camera is installed on the rear surface side of a plate-shaped transparent cover provided on the bezel.

The electronic apparatus is aesthetically undesirable if the camera is noticeable. For this reason, a light shielding section is formed on the cover except for the opening for the camera to receive light. The light shielding section can hide a part of the camera (e.g., the concave-convex engagement section of the lens holder), so that the aesthetic appearance of the electronic apparatus can be improved. The size of the opening is determined such that the camera can secure a sufficient viewing angle.

### SUMMARY OF THE INVENTION

In the above-described electronic apparatus, the relative positions of the camera and the cover may be shifted due to variations in the dimensions of the components, variations in assembly of the components, or the like. Misalignment of the opening with respect to the camera affects the aesthetic appearance of the electronic apparatus because a part of the camera becomes visible. If the diameter of the opening is reduced to avoid this problem, then the viewing angle of the camera may be restricted by the light shielding section, leading to degradation of the optical performance. Thus, there has been a demand for securing the optical performance of the camera without degrading the aesthetic appearance of the electronic apparatus.

An object of an aspect of the present invention is to provide an electronic apparatus capable of securing the optical performance of a camera without degrading the aesthetic appearance of the electronic apparatus, and a manufacturing method for the electronic apparatus.

An aspect of the present invention provides an electronic apparatus including: a chassis; a display mounted on the chassis; a camera which is mounted on the chassis and has a light receiving section that receives light; and a plate-shaped cover member that covers the camera, wherein, on the cover member, a light transmission section that encompasses the light receiving section as viewed from the direction of an optical axis of the camera, a ring-shaped low transmission section that surrounds the light transmission section, and a light shielding section that surrounds the low transmission section are formed, and the low transmission section has a transmittance of 80% or more of infrared rays of a wavelength of 850 nm as compared with the light transmission section, and a transmittance of 20% or less of visible rays of a wavelength of 550 nm as compared with the light transmission section.

Preferably, the low transmission section is formed of a low transmission film formed on the cover member by printing, and the light shielding section is formed of a light shielding film formed on the cover member by printing.

Preferably, the electronic apparatus has a concave or convex engagement section formed on a peripheral edge of the camera.

Another aspect of the present invention provides a manufacturing method for the electronic apparatus, having: a first film formation step of forming the light shielding film on the cover member; and a second film formation step of forming the low transmission film on the cover member with the light shielding film formed thereon.

Still another aspect of the present invention provides an electronic apparatus including: a chassis; a display mounted on the chassis; a camera which is mounted on the chassis and has a light receiving section that receives light; and a plate-shaped cover member that covers the camera, wherein a light transmission section that encompasses the light receiving section as viewed from the direction of an optical axis of the camera, a ring-shaped low transmission section that surrounds the light transmission section and has a lower transmittance of infrared rays of a wavelength of 850 nm as compared with the light transmission section, and a light shielding section that surrounds the low transmission section and has a lower transmittance of infrared rays of a wavelength of 850 nm than that of the low transmission section are formed on the cover member.

Yet an aspect of the present invention provides an electronic apparatus capable of securing the optical performance of a camera without degrading the aesthetic appearance of the electronic apparatus, and a manufacturing method for the electronic apparatus.

### BRIEF DESCRIPTION OF THE DRAWINGS

FIG. 1 is a perspective view of an electronic apparatus according to an embodiment.

FIG. 2 is a perspective view of a part of the electronic apparatus according to the embodiment.

FIG. 3 is a front view of a camera.

FIG. 4 is a sectional view of a part of the electronic apparatus according to the embodiment.

FIG. 5 presents front views of a part of the electronic apparatus according to the embodiment.

FIG. 6 is a perspective view illustrating an example of a method for forming a low transmission section and a light shielding section.

FIG. 7 presents front views of a part of an electronic apparatus according to a comparative form.

### DETAILED DESCRIPTION OF THE INVENTION

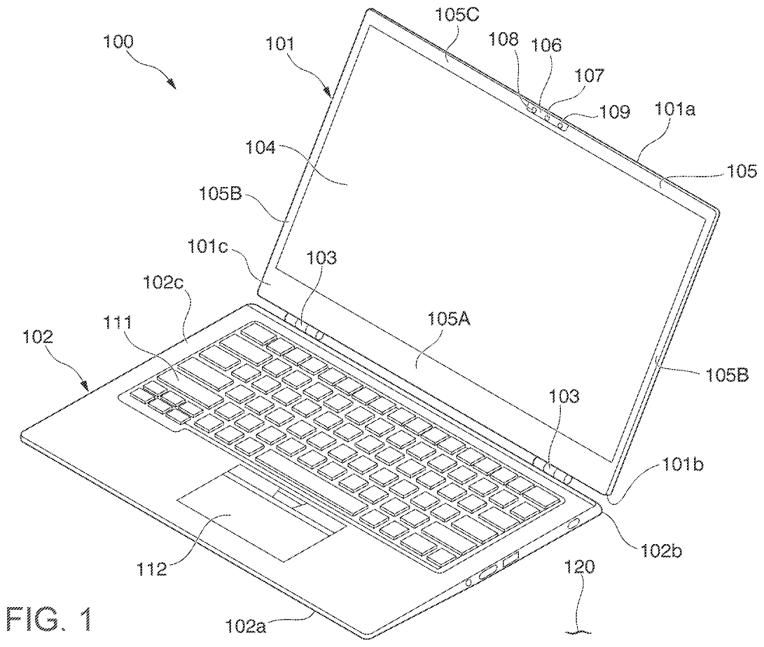

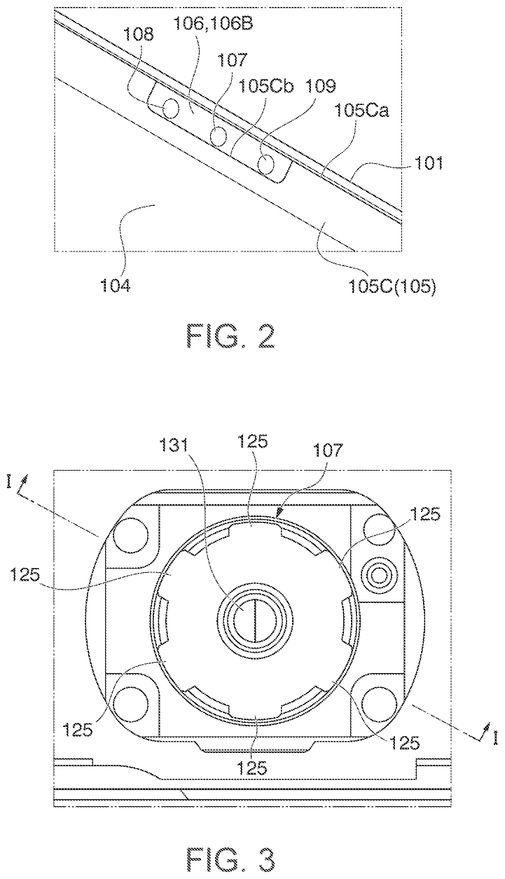

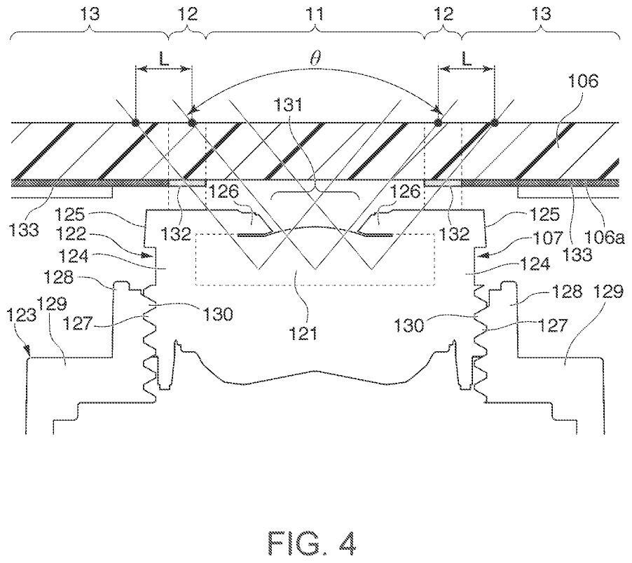

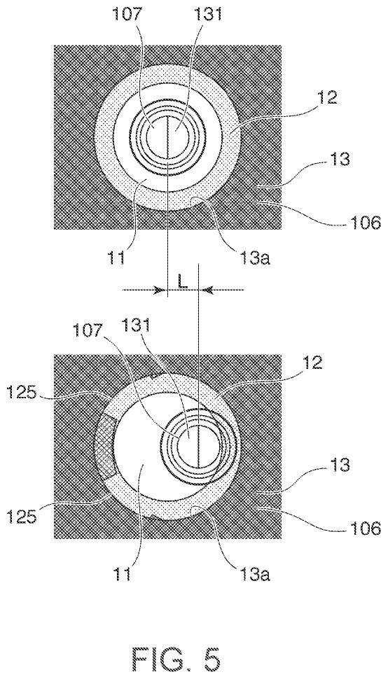

FIG. 1 is a perspective view of an electronic apparatus 100 according to an embodiment. FIG. 2 is a perspective view of a part of the electronic apparatus 100. FIG. 3 is a front view of a camera 107. FIG. 4 is a sectional view of a part of the electronic apparatus 100. FIG. 4 is a sectional view taken along I-I illustrated in FIG. 3. FIG. 5 presents the front views of a part of the electronic apparatus 100.

### Electronic Apparatus

As illustrated in FIG. 1, the electronic apparatus 100 includes a first chassis 101 (chassis), a second chassis 102, a hinge mechanism 103, a display 104 (display device), a frame body 105, a cover member 106, a camera 107, an IR light emitter 108, and a proximity sensor 109. The electronic apparatus 100 is, for example, a clamshell-type laptop PC (Personal Computer).

The first chassis 101 and the second chassis 102 are shaped like rectangular plates. The first chassis 101 and the second chassis 102 are connected with each other at end portions thereof through hinge mechanisms 103. A first proximal end portion 101b of the first chassis 101 is the end portion where the hinge mechanism 103 is provided. A first free end portion 101a is the end portion on the opposite side from the first proximal end portion 101b.

A second proximal end portion 102b of the second chassis 102 is the end portion where the hinge mechanism 103 is provided. A second free end portion 102a is the end portion on the opposite side from the second proximal end portion 102b. The second chassis 102 is relatively rotatable with respect to the first chassis 101 about the rotation axis formed by the hinge mechanisms 103. The opening angle formed between the first chassis 101 and the second chassis 102 can be selected within the range of, for example, 0° or more and 180° or less.

FIG. 1 illustrates a state in which the first chassis 101 is open with an opening angle of approximately 100° with respect to the second chassis 102. In FIG. 1, the second chassis 102 is parallel to a mounting surface 120, so that the first chassis 101 is upright with respect to the mounting surface 120.

The first chassis 101 has the display 104, which has a rectangular shape, mounted thereon. The display 104 is, for example, a liquid crystal display, an organic EL (Electro-Luminescence) display, or the like. The first chassis 101 is referred to also as a display chassis. An inner surface 101c of the first chassis 101 is the surface on which the display 104 is provided. The display 104 displays images based on the processing performed by the electronic apparatus 100.

The second chassis 102 has a keyboard 111 and a touchpad 112 mounted thereon. The keyboard 111 and the touchpad 112 are examples of input devices. A battery, a storage device, and the like are mounted in the second chassis 102. The second chassis 102 is referred to also as a system chassis.

An inner surface 102c of the second chassis 102 is the surface on which the keyboard 111 and the touchpad 112 are provided. When the opening angle of the first chassis 101 with respect to the second chassis 102 is 0°, the inner surface 102c is opposed to the inner surface 101c of the first chassis 101.

The frame body 105 (bezel) is provided on the first chassis 101. The frame body 105 is formed to have a rectangular shape surrounding the display 104. The frame body 105 is provided on the inner surface 101c side of the first chassis 101.

The frame body 105 has a lower frame 105A, a pair of side frames 105B, and an upper frame 105C. The lower frame 105A is formed at the lower portion of the first chassis 101 in FIG. 1. The lower frame 105A is linear along the lower edge of the display 104. The pair of side frames 105B linearly extend along the side edges of the display 104 from both ends of the lower frame 105A. The upper frame 105C connects the upper ends of the pair of side frames 105B. The upper frame 105C is formed linearly along the upper edge of the display 104. The lower frame 105A, the side frames 105B, and the upper frame 105C are formed like plates parallel to the first chassis 101.

As illustrated in FIG. 2, a recessed portion 105Cb is formed in an outer edge 105Ca of the upper frame 105C.

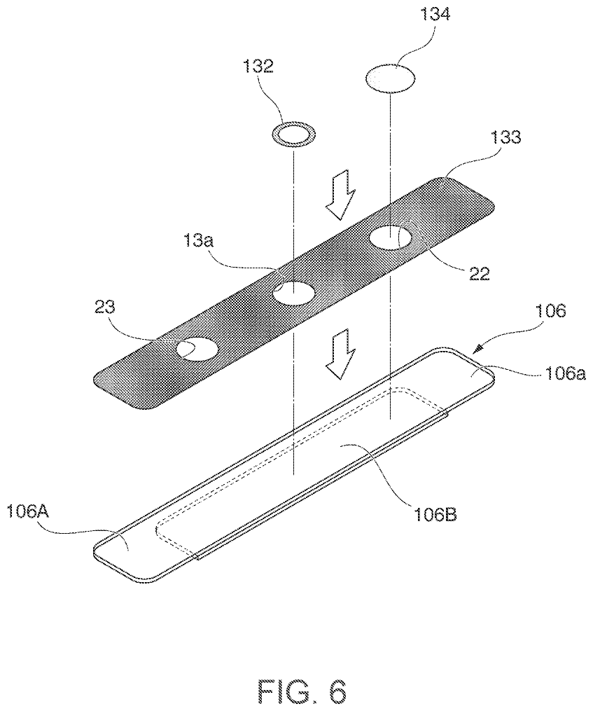

The cover member 106 includes a base board portion 106A, and a thick portion 106B (refer to FIG. 6). The base board portion 106A is formed like a rectangular plate (more specifically, an oblong plate). The thick portion 106B is formed to project from one surface of the base board portion 106A. The thick portion 106B is formed like a rectangular plate (more specifically, an oblong plate). The thick portion 106B is fitted in the recessed portion 105Cb of the upper frame 105C.

The cover member 106 allows electromagnetic waves such as infrared rays and visible rays to pass therethrough in the thickness direction. The cover member 106 is formed of, for example, resin, glass, or the like. Examples of resins forming the cover member 106 include acrylic resins such as polymethyl methacrylate resin (PMMA).

The cover member 106 is provided on the upper frame 105C. The cover member 106 is attached to the upper frame 105C by, for example, attaching the base board portion 106A to the rear surface of the upper frame 105C with an adhesive tape.

The cover member 106 covers the camera 107, the IR light emitter 108, and the proximity sensor 109, as viewed from the inner surface 101c of the first chassis 101 in the thickness direction of the first chassis 101. In other words, the camera 107, the IR light emitter 108 and the proximity sensor 109 are provided adjacently to a rear surface 106a (refer to FIG. 4) of the cover member 106. The rear surface 106a is one surface of the cover member 106.

As illustrated in FIG. 5, a light transmission section 11, a low transmission section 12, and a light shielding section 13 are formed on the cover member 106.

As illustrated in FIG. 4, the light transmission section 11 is an area where no structure that prevents the transmission of light is formed on the rear surface 106a. The light transmission section 11 is circular as viewed from the direction of the optical axis (refer to FIG. 5). The light transmission section 11 encompasses a light receiving section 131 as viewed from the direction of the optical axis of the camera 107 when the light transmission section 11 is positioned concentrically with the camera 107.

As illustrated in FIG. 5, the low transmission section 12 is formed of a low transmission film 132 formed on the rear surface 106a (refer to FIG. 4). The low transmission section 12 is a ring-shaped area having a lower light (visible ray) transmission than the light transmission section 11. The low transmission film 132 is formed in a ring shape surrounding the light transmission section 11.

The low transmission film 132 is formed, for example, in a circular ring shape. The outer peripheral edge of the low transmission film 132 is, for example, along the inner peripheral edge of an opening 13a of the light shielding section 13 (refer to FIG. 5). The low transmission film 132 is formed by a coloring agent or the like that reduces light transmission. The low transmission film 132 can be formed by printing. When located concentrically with the camera 107, the low transmission section 12 surrounds the light receiving section 131 (refer to FIG. 4) as viewed from the direction of the optical axis of the camera 107. The low transmission section 12 is interposed between the light transmission section 11 and the light shielding section 13. The low transmission section 12 is adjacent to the light transmission section 11. The low transmission section 12 is adjacent to the light shielding section 13.

The low transmission section 12 may have a lower transmittance of infrared rays of a wavelength of 850 nm than the transmittance of the light transmission section 11. This makes it possible to suppress the light transmittance (the transmittance of visible rays) of the low transmission section 12. Therefore, even if the relative positions of the camera 107 and the cover member 106 are shifted, the camera 107 can be made inconspicuous.

The low transmission section 12 preferably has a higher transmittance of infrared rays having a wavelength of 850 nm than the transmittance of the light shielding section 13. The higher transmittance of infrared rays having a wavelength of 850 nm than the transmittance of the light shielding section 13 makes it possible to suppress a reduction in the amount of light received by the camera 107, thus improving the optical performance of the camera 107.

The low transmission section 12 preferably has a transmittance of 80% or more (preferably 90% or more) of infrared rays having a wavelength of 850 nm as compared with the light transmission section 11. The transmittance of infrared rays of a wavelength of 850 nm within the above-described range makes it possible to secure the amount of received light and improve the optical performance of the camera 107. The transmittance of infrared rays of a wavelength of 850 nm in the low transmission section 12 is, for example, 80% or more and 100% or less. The transmittance of infrared rays of a wavelength of 850 nm in the low transmission section 12 may be lower than the transmittance of infrared rays of a wavelength of 850 nm in the light transmission section 11, or may be equal to the transmittance of infrared rays of a wavelength of 850 nm in the light transmission section 11.

The low transmission section 12 preferably has a transmittance of 20% or less (preferably 10% or less) of visible rays having a wavelength of 550 nm as compared with the light transmission section 11. The transmittance of visible rays of a wavelength of 550 nm within the above-described range allows the camera 107 to be inconspicuous even if the relative positions of the camera 107 and the cover member 106 are shifted. The transmittance of visible rays having a wavelength of 550 nm in the low transmission section 12 is, for example, 0% or more and 20% or less.

The light shielding section 13 is an area in which the transmission of light (infrared rays and visible rays) is lower than that of the low transmission section 12 due to a light shielding film 133 formed on the rear surface 106a. The light shielding film 133 is formed by a coloring agent or the like that reduces light transmission. The light shielding film 133 can be formed by printing. The light shielding section 13 surrounds the low transmission section 12. The opening 13a is formed in the light shielding section 13. The opening 13a is formed, for example, to have a circular shape that is concentric with the low transmission section 12. The inner diameter of the opening 13a is equal to the outer diameter of the low transmission section 12. The inner diameter of the opening 13a can be determined according to the position and a viewing angle θ of the camera 107 (refer to FIG. 4).

The light shielding section 13 has a lower transmittance of infrared rays of a wavelength of 850 nm as compared with the low transmission section 12. In the light shielding section 13, the transmittance of visible rays of a wavelength of 550 nm is equal to that of the low transmission section 12, or lower as compared with the low transmission section 12.

FIG. 6 is a perspective view illustrating an example of the method for forming the low transmission section 12 and the light shielding section 13. As illustrated in FIG. 6, the following method can be used to form the low transmission section 12 and the light shielding section 13.

### First Film Formation Step: Formation of the Light Shielding Film

The light shielding film 133 is formed on the rear surface 106a of the cover member 106. The light shielding film 133 has the opening 13a, a second opening 22, and a third opening 23. Each of the opening 13a, the second opening 22, and the third opening 23 has a circular shape. The opening 13a is formed at a position corresponding to the camera 107. The second opening 22 is formed at a position corresponding to the IR light emitter 108. The third opening 23 is formed at a position corresponding to the proximity sensor 109.

### Second Film Formation Step: Formation of the Low Transmission Film

The ring-shaped low transmission film 132 is formed on the rear surface 106a of the cover member 106. The low transmission film 132 is formed such that the low transmission section 12 is formed in the opening 13a. The outer diameter of the low transmission film 132 may be equal to the inner diameter of the opening 13a or may be larger than the inner diameter of the opening 13a. A circular low transmission film 134 is formed on the rear surface 106a of the cover member 106. The low transmission film 134 covers the entire area in the second opening 22. The low transmission film 134 has the same characteristics as those of, for example, the low transmission film 132.

As illustrated in FIG. 3 and FIG. 4, the camera 107 includes a lens 121, a lens holder 122, and a mounting base 123 (refer to FIG. 4). The camera 107 is installed to the first chassis 101 (refer to FIG. 1).

As illustrated in FIG. 4, the camera 107 is, for example, an IR camera. The IR camera has a function of capturing images by using infrared rays. The IR camera includes, for example, an IR image sensor in which IR (InfraRed) pixels are arranged. Light including infrared rays is incident on the IR pixels. For example, the camera 107 can receive the reflected light of infrared rays output from the IR light emitter 108, and output, as imaging data, IR image (infrared image) data obtained by photoelectrically converting the incident light.

The wavelength of infrared rays is, for example, 780 nm or more and 1000 nm or less. The wavelength of the visible rays is, for example, 400 nm or more and below 780 nm.

The optical axis of the lens 121 is parallel to the direction of thickness of the first chassis 101. The lens holder 122 has a cylindrical section 124 holding the lens 121. The cylindrical section 124 is formed to have a cylindrical shape, and holds the lens 121 therein. The central axis of the cylindrical section 124 is parallel to the direction of thickness of the first chassis 101.

As illustrated in FIG. 3, a plurality of engagement sections 125 are formed in the peripheral edge portion of a part including the tip of the cylindrical section 124. The engagement sections 125 are convex sections projecting radially outward from the outer peripheral surface of the cylindrical section 124. The plurality of engagement sections 125 are formed in such a manner as to be arranged side by side at intervals in the direction around the axis of the cylindrical section 124 (the direction around the optical axis of the lens 121). The engagement sections 125 are structures for engaging with a rotary tool to rotate the lens holder 122 around the optical axis.

As illustrated in FIG. 4, a ring-shaped holding protruding portion 126 holding the lens 121 is formed on the inner peripheral surface of the cylindrical section 124. The holding protruding portion 126 projects radially inward from the inner peripheral surface of the cylindrical section 124. The light receiving section 131, through which the camera 107 receives light, is the inner side of the holding protruding portion 126 as viewed from the direction of the optical axis of the lens 121.

A threaded section 127 is formed on the outer peripheral surface of the cylindrical section 124. The threaded section 127 is screwed to a threaded section 130 of the mounting base 123. The lens holder 122 is screwed to the threaded section 130 thereby to be attached to the mounting base 123. The position of the lens holder 122 in the direction of the optical axis can be adjusted by being rotated around the optical axis. This allows the camera 107 to perform focusing.

The mounting base 123 includes a mounting section 128 and a base 129. The mounting section 128 is formed to have a cylindrical shape. The mounting section 128 has the threaded section 130 formed on the inner peripheral surface thereof. The base 129 extends radially outward from the outer peripheral surface of the mounting section 128.

Referring to FIG. 4, “θ” denotes the viewing angle of the camera 107. “L” denotes the maximum tolerance of the cover member 106 and the camera 107 (the maximum tolerance in the direction orthogonal to the optical axis).

As illustrated in FIG. 2, the IR light emitter 108 outputs infrared rays for irradiating an imaging target of the camera 107. The IR light emitter 108 is, for example, an LED outputting infrared rays. The IR light emitter 108 is installed to the first chassis 101.

The proximity sensor 109 detects the approach of an object by a physical amount, which changes when the object approaches. The proximity sensor 109 is, for example, a capacitance sensor. A capacitance sensor detects capacitance as a physical amount. The proximity sensor 109 is installed to the first chassis 101.

### Effect Provided by the Electronic Apparatus of the Embodiment

The low transmission section 12 has a transmittance of 80% or more of infrared rays of a wavelength of 850 nm as compared with the light transmission section 11. The low transmission section 12 has a transmittance of 20% or less of visible rays of a wavelength of 550 nm as compared with the light transmission section 11. This makes it possible to enhance the optical performance of the camera 107, and to make the camera 107 inconspicuous even if the relative positions of the camera 107 and the cover member 106 are shifted.

For example, even if dislocation by a distance L in the direction orthogonal to the optical axis takes place between the camera 107 and the cover member 106 as illustrated in FIG. 5, the low transmission section 12 makes the engagement sections 125 of the camera 107 inconspicuous.

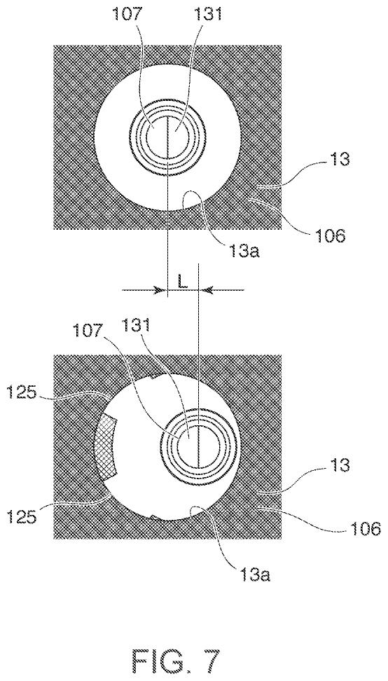

FIG. 7 is a front view of a part of an electronic apparatus according to a comparative form. As illustrated in FIG. 7, in the case where the low transmission section 12 is absent, if the dislocation by the distance L between the camera 107 and the cover member 106 takes place, the engagement sections 125 of the camera 107 may become conspicuous. This is aesthetically undesirable.

The low transmission section 12 is formed by the low transmission film 132 formed by printing. The light shielding section 13 is formed by the light shielding film 133 formed by printing. Thus, the low transmission section 12 and the light shielding section 13 can be easily formed.

The engagement sections 125 are formed on the peripheral edge of the lens holder 122 of the camera 107. Therefore, it can be said that the camera 107 has a concave-convex structure that makes the camera 107 visually recognizable with ease from outside; however, since the electronic apparatus 100 has the low transmission section 12, the concave-convex structure of the camera 107 can be made inconspicuous.

The low transmission section 12 has a lower transmittance of infrared rays of a wavelength of 850 nm as compared with the light transmission section 11. The light shielding section 13 has a lower transmittance of infrared rays of a wavelength of 850 nm as compared with the low transmission section 12. This makes it possible to enhance the optical performance of the camera 107, and to make the camera 107 inconspicuous even if the relative positions of the camera 107 and the cover member 106 are shifted.

### Effect Provided by the Manufacturing Method for the Electronic Apparatus of the Embodiment

As illustrated in FIG. 6, the manufacturing method for the electronic apparatus of the present embodiment has a first film formation step of forming the light shielding film 133 on the cover member 106, and a second film formation step of forming the low transmission film 132 on the cover member 106 on which the light shielding film 133 has been formed. Consequently, the outline of the low transmission film 132 is hidden by the light shielding film 133 and becomes less noticeable. This is desirable in terms of the aesthetic appearance of the electronic apparatus 100.

The specific configurations of the present invention are not limited to those of the embodiment described above, and include designs and the like within a range that does not depart from the gist of the present invention. The configurations described in the above-described embodiment can be arbitrarily combined.

In the above-described embodiment, the plurality of engagement sections 125 are formed on the camera 107, and the number of the engagement sections is not particularly limited. The number of the engagement sections may be one or plural (any number of two or more).

The engagement sections may alternatively be recessed portions formed on the peripheral edge of a camera. The recessed portions are, for example, recessed radially inward from the peripheral edge of the camera. The number of the recessed portions may be one or plural. A plurality of recessed portions are, for example, formed in such a manner as to be arranged side by side at intervals in the direction around an optical axis.

The structure of the engagement section formed on a camera is not particularly restricted as long as the engagement section can engage with a rotary tool to rotate a lens holder.

The low transmission section may alternatively be formed by attaching a low transmission sheet to the cover member rather than being limited to the formation by printing. The light shielding section may alternatively be formed by attaching a light shielding sheet to the cover member rather than being limited to the formation by printing.

The transmittance of infrared rays and visible rays can be measured using, for example, a UV-Vis-NIR spectrometer (Perkin Elmer, LAMBDA 1050+). Transmittance indicates the rate at which incident light is transmitted through an object.

The electronic apparatus of the embodiment is not limited to a laptop PC, but may alternatively be a smartphone, a tablet terminal, or the like.

1. An electronic apparatus comprising:
a chassis;
a display mounted on the chassis;
a camera mounted on the chassis and has a light receiving section that receives light; and
a plate-shaped cover member that covers the camera,
wherein, the cover member includes:
a light transmission section that encompasses the light receiving section as viewed from a direction of an optical axis of the camera,
a ring-shaped low transmission section that surrounds the light transmission section, and
a light shielding section that surrounds the low transmission section are formed, and
the low transmission section has a transmittance of 80% or more of infrared rays of a wavelength of 850 nm and has a transmittance of 20% or less of visible rays of a wavelength of 550 nm.

2. The electronic apparatus according to claim 1,
wherein the low transmission section includes a low transmission film on the cover member, which low transmission film is formed by printing, and
the light shielding section includes a light shielding film on the cover member, which light shielding film is formed by printing.

3. The electronic apparatus according to claim 1,
wherein an engagement section, which is a concave portion or a convex portion, is on a peripheral edge of the camera.

4. A manufacturing method for the electronic apparatus described in claim 2, comprising:
a first film formation step of forming the light shielding film on the cover member; and
a second film formation step of forming the low transmission film on the cover member having the light shielding film formed thereon.

5. An electronic apparatus comprising:
a chassis;
a display mounted on the chassis;
a camera mounted on the chassis and has a light receiving section that receives light; and
a plate-shaped cover member that covers the camera,
wherein, the cover member includes:
a light transmission section that encompasses the light receiving section as viewed from a direction of an optical axis of the camera,
a ring-shaped low transmission section that surrounds the light transmission section and has a lower transmittance of infrared rays of a wavelength of 850 nm, as compared with the light transmission section, and
a light shielding section that surrounds the low transmission section and has a lower transmittance of infrared rays of a wavelength of 850 nm as compared with the low transmission section are formed.
